(19) United States
(12) Patent Application Publication
(10) Pub. No.: US 2014/0324936 A1
(43) Pub. Date: Oct. 30, 2014

(54) PROCESSOR FOR SOLVING MATHEMATICAL OPERATIONS

(71) Applicant: Texas Instruments Incorporated, Dallas, TX (US)

(72) Inventors: Tessarolo Alexander, Lindfield (AU); Chirag Gupta, Ahmedabad (IN)

(73) Assignee: Texas Instruments Incorporated, Dallas, TX (US)

(21) Appl. No.: 13/971,635

(22) Filed: Aug. 20, 2013

Related U.S. Application Data
(60) Provisional application No. 61/817,780, filed on Apr. 30, 2013.

(51) Int. Cl. G06F 17/10

(52) U.S. Cl. CPC G06F 17/10
USPC 708/404; 708/523; 708/440

(57) ABSTRACT

Processors and methods for solving mathematical equations are disclosed herein. An embodiment of the processor includes a hardware device that calculates coefficients based on a mathematical operation that is to be performed. An indexing device transmits the coefficients to and from a look up table. A hardware multiplier multiplies certain coefficients by the derivative of a function related to the mathematical operation. A hardware adder adds a first coefficient to the product of a second coefficient and the first order derivative of the function.

This application claims priority to U.S. patent provisional patent application 61/817,780 filed on Apr. 30, 2013 for PROCESSOR FOR SOLVING MATHEMATICAL OPERATIONS, which is hereby incorporated for all that is disclosed therein.

### BACKGROUND

Many microprocessors use hardware multipliers and adders, which reduce the time required to execute multiplication and addition operations. However, many algorithms involve other operations, such as division, square root, and trigonometric functions. These functions may take several hundred cycles on the microprocessor to execute, which significantly restricts the speed of the microprocessor.

### SUMMARY

Processors and methods for solving mathematical equations are disclosed herein. An embodiment of the processor includes a hardware device that calculates coefficients based on a mathematical operation that is to be performed. An indexing device transmits the coefficients to and from a look up table. A hardware multiplier multiplies certain coefficients by the derivative of a function related to the mathematical operation. A hardware adder adds a first coefficient to the product of a second coefficient and the first order derivative of the function.

### BRIEF DESCRIPTION OF THE DRAWINGS

FIG. 1 is a block diagram of an embodiment of a trigonometric math unit.

FIG. 2 is a flow chart describing an embodiment using the trigonometric math unit of FIG. 1.

FIG. 3 is another flow chart describing another embodiment of using the trigonometric math unit of FIG. 1.

### DETAILED DESCRIPTION

Many microprocessors implement fast hardware for multiplying and adding numbers. The fast hardware enables the microprocessors to perform addition and multiplication operations using hardware, which is very fast. The solutions for many complex algorithms involve the execution of different operations, such as division, square root, matrices, and different trigonometric operations, such as cosine, sine, and arctangent. Examples of such algorithms include, Park transforms, DQ0 transforms, and fast Fourier transforms, including phase and magnitude. These algorithms typically take many cycles to complete when processed using software, for example, they may take approximately 100 cycles to complete. The large number of cycles significantly slows the microprocessor, especially when it is running a program that executes many of these operations and algorithms.

Different methods of solving mathematical equations exist, but they have drawbacks. For example, some methods use look up tables to quickly find the result of an operation rather than compute the result. However, the look up tables have to be enormous and result in read-only memory (ROM) that is excessively large. When used in a processor that performs many different algorithms, the ROM would take up too much area on the microprocessor chip and be very costly. Other methods approximate the results using polynomials. These methods do not use the ROM required for the look up tables, but the amount of computation is very high, which requires many cycles and slows the microprocessor.

The trigonometric math unit (TMU) and methods described herein use a combination of look up tables and polynomials to solve complex mathematical operations. The combination reduces the computational complexity when solving complex operations and does not require excessive ROM. In summary, the TMU breaks up operations into second order coefficients, wherein the coefficients are used to perform the operations using a second order approximation. The coefficients are stored in look up tables in a ROM device that the TMU indexes. The second order approximations are solved using addition and multiplication operations that are performed by hardware. Therefore, the coefficient values are stored in a look up table and the approximations are solved using multiplication and addition on the coefficients. This process utilizes hardware in the TMU to perform the operations, which minimizes the slower software computations. The result is a fast and accurate solution to the operations.

Having summarily described the TMU and methods for solving mathematical operations and equations, the TMU and methods will now be described in greater detail. The TMU solves operations using a second order approximation defined as:

Y=Y0+S1dx+S2dx² Equation (1)

The solution using equation 1 involves addition and multiplication, which are processed using hardware in the TMU. For example, the coefficient S1 is multiplied by the first order derivative of x and the coefficient S2 is multiplied by the second order derivative of x. These terms along with the coefficient Y0 are added together. The coefficient S1 may be the first order derivative of the operation being evaluated and the coefficient S2 may be the second derivative of the operation being evaluated. For example, if the operation being evaluated is sin(x), the coefficient S1 may be cos(x) and the coefficient S2 may be −cos(x). The TMU may approximate these coefficients in some embodiments. After the coefficients are determined, the solution to equation 1 is readily calculated using hardware. More specifically, a hardware multiplier multiplies the second coefficient S1 by the first order derivative of the function x and the third coefficient S2 by the second order derivative of x. Therefore, rather than calculating the complex mathematical equation of a function, the TMU disclosed herein simply calculates coefficients and derivatives. The coefficients and derivatives are added and multiplied by hardware, so the solution of the mathematical operation is generated very quickly and with minimal resources.

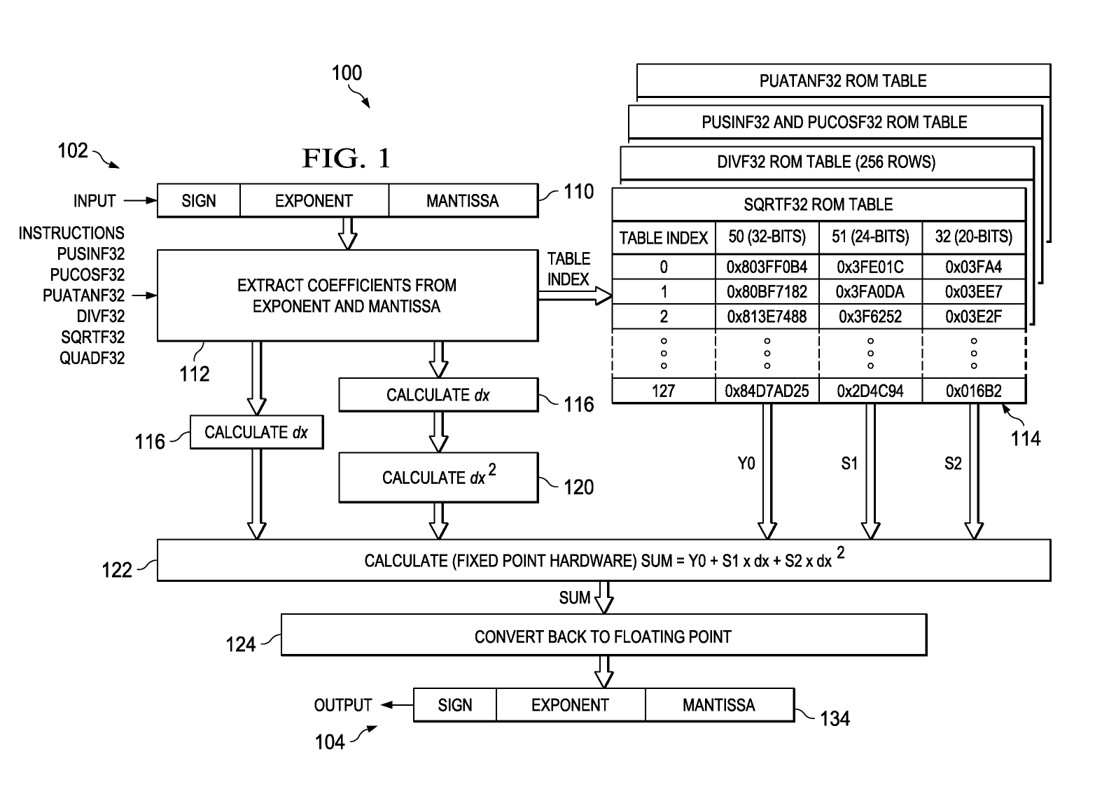

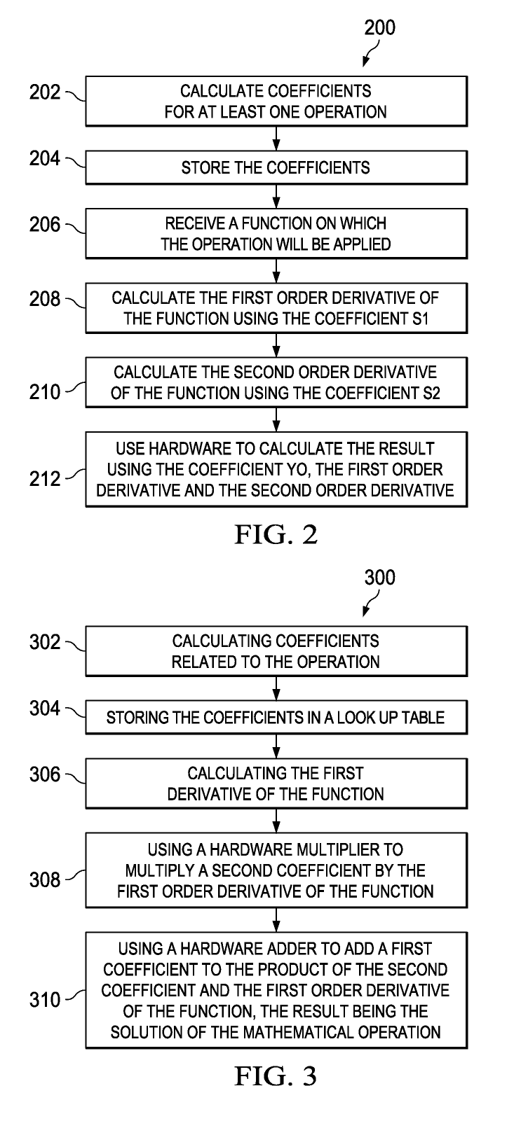

Reference is made to FIG. 1, which is a block diagram of a TMU 100. Reference is also made to FIG. 2, which is a flow chart describing the operation of the TMU 100 of FIG. 1. The TMU 100 may solve a plurality of different mathematical operations using the second order approximation described above. The operations include different mathematical functions, such as division and trigonometric operations. For example, the operation or function may be a sine function that is solved for x, resulting in the TMU 100 solving for sin(x). Other examples of the TMU 100 solving other operations, such as 1/x, will be described below. The TMU 100 has an input 102 wherein a number that is to be solved for based on the function is received. The number may be in scientific notation wherein it has an exponent and a mantissa. The TMU 100 performs a mathematical operation based on the input number and outputs a result at an output 104. The output may be a floating point number having an exponent and a mantissa.

The TMU 100 extracts the exponent and mantissa at a first instruction 110. A hardware device 112 extracts the coefficients Y0, S1, and S2 based on specific mathematical operations. As stated above, a specific operation may be performed on a function, so the hardware device 112 generates the coefficients based on the operations being performed, which is shown in step 202 of FIG. 2. These coefficients are referred to as Y0, S1, and S2 as described above. As stated above, the coefficient Si may be the first order derivative of the operation being evaluated and the coefficient S2 may be the second order derivative of the operation being evaluated. It is noted that the TMU 100 may receive an instruction to perform specific mathematical operations or it may be programmed to perform specific mathematical operations. These mathematical operations may include, for example, sine, cosine, arctangent, division, and square roots. Different coefficients may be calculated based on the different operations.

The values for Y0, S1, and S2, which are the above-described coefficients, are stored in the above-described tables as shown in step 204 of FIG. 2. With reference to FIG. 1, the coefficients are stored in the table 114, which may be a look up table. It is noted that the table 114 is arranged so that there are different coefficients for different mathematical operations. For example, the table 114 may store coefficients for square root, sine, arctangent, and other operations. Hardware indexing may be used to store and/or retrieve the coefficients, which increases the speed at which the operations are calculated.

In step 206, a number or function to which the operation will be applied is received. In step 208, the first order derivative of the function using the coefficient Si is calculated. The derivative may be calculated using a hardware device 116 in the TMU 100. Because the hardware device 116 is used, the derivative calculation is relatively fast. It is noted that the derivative calculation is shown twice in the TMU 100, which is done for simplicity. As described above, the second order derivative of the function x is also calculated, so the derivative calculation is shown as two steps, one related to S1 and the other related to S2. In step 210, the second order derivative of the function x (dx²) using the coefficient S2 is calculated. The calculation of dx² may be performed by a hardware device 120 in the TMU 100. Again, because this calculation is performed using hardware, it may be done quickly.

At this point, the coefficients for the operation have been calculated and are stored in the table 114. In addition, the first and second order derivatives of x have been calculated and may be stored in registers or the like that are readily indexed. The solution using equation 1 may be calculated using a hardware device 122 and as shown in step 212. It is noted that the hardware device 122 may be the same one as those described above, such as the hardware devices 112, 116, and 120. The hardware devices have been separated in FIG. 1 for simplicity. The hardware device 122 retrieves the coefficients and adds the coefficient Y0 to the product of the coefficient S1 and the first order derivative of the function x. The hardware device 122 also adds the product of the third coefficient S2 and the second order derivative of the function x to the previous sum, the result is the solution to the operation. Another hardware device 124 may convert the result of equation 1 to floating point number with an exponent and a mantissa. The result is output at the output 104.

Having described the TMU 100 and its operation, an example of the calculations that may be performed for the operations of sine and cosine will now be described. The following is based on the operation of:

Y=sin(2πx) Equation (2)

where: −1.0<x<1.0

Using Euler's formula, x is set by equation 3 as follows:

x=x0(n)+dz Equation (3)

The value of n is a sampling number, which may be a whole number. For example, n may be between one and 256. Continuing with Euler's formula, sin(2πx) is expressed by equation 4 as follows:

sin(2πx)=Y0+S1(dz)+S2(dz)(dz) Equation (4)

where: Y0=sin(2 πx0(n)) Equation (5)

S1=cos(2πx0(n))(2π)/2 Equation (6)

S2=−sin(2πx0(n))(2π)(2π)/2 Equation (7)

In some embodiments, equation 4 requires a table size of 256 in order to achieve a required accuracy. The equations above can be modified slightly to reduce the table size to 128 and increase the accuracy. In this case, equation 8 sets forth a value of x as follows:

x=x1(n)+/−dx Equation (8)

where x1(n) is the midpoint between the x0(n) samples and wherein:

x1(n)=x0+dx0; and Equation (9)

dx0=1/1024=0.000977 Equation (10)

It is noted that the value of dx0 has been rounded and that it may include more significant figures. In this embodiment, equation 4 is applied, but the coefficients are different. The coefficients are calculated as follows:

Y0=sin(2πx1) Equation (11)

S1=cos(2πx0)(2π)−sin(2πx0)(dx0)2π)(2π)−cos(2πx0)(dx0)dx0)(2π)³/2 Equation (12)

S2=−sin(2πx0)(2π)²/2−cos(2πx0)(dx0)(2π)³/2 Equation (13)

In the embodiment described above, only one quarter of the sine table is required because of symmetry. In other words, the coefficients repeat. When the above equations are performed in the hardware device 112, x0 and x1 may be calculated as follows:

x0=n/512 for n=0 to 127 Equation (14)

where 0.0<=dz<(1/512 or 0.0195); and

x1n/512+1/1024 for n=0 to 127 Equation (15)

where (−1/1024 or −0.000977)<=dx<(1/1024 or 0.000977)

Having described the method of calculating sine, the calculation of inverse x will now be described. The Newton-Raphson approximation may be used to calculate the coefficients Y0, S1, and S2 for the operation of the inverse of x. The coefficients are then used to calculate the value using the second order calculation of equation 1. The calculation commences with setting a variable Y, which is equal to the inverse of the square root of x. The process continues with calculating Y as follows:

Y=Y0+dy Equation (16)

A variable x is equal to:

x=x0+dx Equation (17)

Based on the Newton-Raphson approximation a value of Y1 is calculated as follows:

Y1=2Y0−(x)(Y0²) Equation (18)

It follows that:

Y=2Y1−(x)(Y1²) Equation (19)

By substitution, Y is expressed by the following equation:

Y=2(2Y0−(x)(Y0²))−x(2Y0−2(x)(Y0²))² Equation (20)

By further substitution, Y is expressed by the following equation:

Y=(4Y0−6(x0)(Y0)²+4(Y0)³x0²−(Y0⁴)x0³)−(6(Y0²)−8(Y0³)x0+3(Y0)⁴(x0)²)dx+(4(Y0)³−3(Y0)⁴x0)dx²−(Y0)⁴dx³ Equation (21)

Four coefficients are established in equation 21, which are given as follows:

C0=Y0=4Y0−6(x0)(Y0)²+4(Y0)³x0²−(Y0⁴)x0³ Equation (22)

C1=6(Y0²)−8(Y0³)x0+3(Y0)⁴(x0)² Equation (23)

C2=4(Y0)³−3(Y0)⁴x0 Equation (24)

C3=−(Y0)⁴ Equation (25)

After substituting equations 22, 23, 24, and 25 into equation 21, a solution for Y is generated. In order to simplify the equation for Y, it is written using coefficients C1-C4 as follows:

Y=Y0C1dx+2dx²+C3dx³+C4dx⁴ Equation (26)

The ranges of the coefficients and variables are given as follows:
X0: 1.0 to 2.0
Y0: 1.0 to 0.5
C1: −1.0 to −0.25
C22: 1.0 to 0.125
C3: −1.0 to −0.0625

It is noted that the ranges given above may be given using more significant numbers, but have been limited herein for simplicity. The equations for x and Y can be modified as follows to improve accuracy.

x=x0+dx0+/−dx Equation (27)

Y=Y0+S1dx+S2dx²+S3dx³ Equation (28)

The coefficients of Y0, S1, and S2 are defined as follows:

Y0=1/(X0+dx0) Equation (29)

S1=C1+2(C2)dx0+3(C3)(dx0)² Equation (30)

S2=C2+3(C3)dx0 Equation (31)

S3=C3 Equation (32)

Because the value for S3 is so small, it can be ignored, so that the solution of Y is written as the second order approximation of:

Y=Y0+S1dx+S2dx² Equation (24)

These coefficients are stored in the look up table 114 and indexed by the TMU 100 to solve the operation of inverse x.

FIG. 3 is a flow chart 300 showing another embodiment of using the TMU 100 of FIG. 1. In step 302, coefficients related to the operation are calculated. In step 304, the coefficients are stored in a look up table. In step 306, the first derivative of the function is calculated. In step 308, a hardware multiplier is used to multiply a second coefficient by the first derivative of the function. In step 320, a hardware adder is used to add a first coefficient to the product of the second coefficient and the first order derivative of the function, the result being the solution of the mathematical operation.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A processor for solving mathematical operations, the processor comprising:
a hardware device that calculates coefficients based on the mathematical operation;
an indexing device that transmits the coefficients to a look up table;
a hardware multiplier that multiplies certain coefficients by the derivative of a function related to the mathematical operation; and
a hardware adder that adds a first coefficient to the product of a second coefficient and the first order derivative of the function.

2. The processor of claim 1, wherein the operation is a fast Fourier transform.

3. The processor of claim 1, wherein the operation comprises a trigonometric function.

4. The processor of claim 1, wherein the operation comprises a matrix.

5. The processor of claim 1, wherein the look up table is read only memory.

6. The processor of claim 1, wherein the hardware adds a first coefficient to the product of a second coefficient and the first order derivative of the function and to the product of a third coefficient and the second order derivative of the function.

7. The processor of claim 6, wherein the second order derivative is calculated by hardware.

8. The processor of claim 1, wherein the first order derivative is calculated by hardware.

9. The processor of claim 1, wherein the coefficients are derivatives of the operation.

10. A method for solving a mathematical operation on a function using a microprocessor, the method comprising:
calculating coefficients related to the operation;
storing the coefficients in a look up table;
calculating the first derivative of the function;
using a hardware multiplier to multiply a second coefficient by the first derivative of the function;
using a hardware adder to add a first coefficient to the product of the second coefficient and the first order derivative of the function, the result being the solution of the mathematical operation.

11. The method of claim 10 and further comprising:
using the hardware multiplier to multiply a third coefficient by the second order derivative of the function; and
using the hardware adder to add the product of the third coefficient and the second order derivative of the function to the sum of the first coefficient and the product of the second coefficient and the first order derivative of the function.

12. The method of claim 11, wherein the second order derivative is calculated using hardware.

13. The method of claim 10, wherein the first order derivative is calculated using hardware.

14. The method of claim 10, wherein the operation comprises a fast Fourier transform.

15. The method of claim 10, wherein the operation comprises a trigonometric function.

16. The method of claim 10, wherein the operation comprises a matrix.

17. The method of claim 10, wherein the look up table is read only memory.

18. A processor for solving mathematical operations, the processor comprising:
a hardware device that calculates first, second, and third coefficients based on the mathematical operation;
an indexing device that transmits the coefficients to and from a look up table;
a hardware multiplier that multiplies the second coefficient by the first order derivative of a function related to the mathematical operation and wherein the hardware multiplier multiplies the third coefficient by the second order derivative of the function; and
a hardware adder that adds a first coefficient to the product of the second coefficient and the first order derivative of the function and the product of the third coefficient and the second order derivative of the function.
